(19) United States
(12) Patent Application Publication
(10) Pub. No.: US 2023/0219835 A1
(43) Pub. Date: Jul. 13, 2023

(54) HIGH-GENERATION TFT-LCD GLASS SUBSTRATE PRODUCTION LINE

(71) Applicants: BENGBU CHINA OPTOELECTRONIC TECHNOLOGY CO., LTD, Bengbu (CN); (CNBM) BENGBU DESIGN & RESEARCH INSTITUTE FOR GLASS INDUSTRY CO., LTD, Bengbu (CN)

(72) Inventors: Shou Peng, Bengbu (CN); Chong Zhang, Bengbu (CN); Liangmao Jin, Bengbu (CN); Longyue Jiang, Bengbu (CN); Zhiqiang Cao, Bengbu (CN); Mingliu Zhu, Bengbu (CN); Yuguo Shen, Bengbu (CN)

(21) Appl. No.: 17/778,255

(22) PCT Filed: Apr. 23, 2021
(86) PCT No.: PCT/CN2021/089346

§ 371 Date: May 19, 2022

(30) Foreign Application Priority Data
Jun. 8, 2020 (CN) 202010510899.7

(51) Int. Cl. C03B 5/027; C03B 5/235; C03B 5/225; C03B 5/18; C03B 18/02; C03B 25/00; C03B 33/02

(52) U.S. Cl. CPC C03B 5/027; C03B 5/2353; C03B 5/225; C03B 5/18; C03B 18/02; C03B 25/00; C03B 33/02

(57) ABSTRACT

The present invention relates to a high-generation TFT-LCD glass substrate production line. The production line includes a kiln, a large-flow precious metal channel, a tin bath, an annealing kiln, a cutting machine and an unloading machine connected in sequence. The present invention combines high-efficiency melting, clarification and homogenization of molten glass, ultrathin float forming and annealing process technologies of the TFT-LCD glass, which can produce the TFT-LCD glass substrates with large sizes such as 8.5 generations and 10.5/11 generations, which has the advantages of large product size, excellent product performance, coherent process procedures, high production efficiency, high productivity and the like.

The present application claims the priority to a Chinese patent application No. 202010510899.7 filed with the China National Intellectual Property Administration on Jun. 8, 2020 and entitled “High-generation TFT-LCD Glass Substrate Production Line”, which is incorporated herein by reference in its entirety.

### TECHNICAL FIELD

The present invention relates to the field of high-generation TFT-LCD glass production, and specifically relates to a high-generation TFT-LCD glass substrate production line.

### BACKGROUND

TFT-LCD glass substrate is a key strategic material in the electronic information display industry, and represents the highest level in the field of glass manufacturing. At present, China has become the world's largest information display industry base. In 2018, the demand for glass substrates in mainland China was about 260 million square meters, of which the demand for 8.5-generation glass substrates was 233 million square meters. By 2020, China's 8.5-generation and above TFT-LCD glass substrate market demand will exceed 300 million square meters, accounting for more than 50% of the global total demand, and the market space and development potential are huge.

Chinese invention patent CN 200810054509 describes the TFT-LCD glass substrate automatic processing production line, which involves the entire process of cutting, grinding, inspection, and packaging. However, this patent does not involve the production process of the original glass substrate; Chinese invention patent CN 201611102225 relates to a heating system and a cleaning machine for a substrate glass cleaning machine. It mainly explains the automatic heating system used on the glass substrate post-processing cleaning machine and the cleaning machine applying the heating system. However, the invention does not involve the technical content of the high-generation TFT-LCD glass substrate production line.

### SUMMARY

The present invention is to overcome the shortcomings in the prior art and provide a high-generation TFT-LCD glass substrate production line. This application provides the following technical solution:

A high-generation TFT-LCD glass substrate production line includes a kiln, a precious metal channel, a tin bath, an annealing kiln, a cutting machine, and an unloading machine connected in sequence. The kiln includes a set of electrodes symmetrically arranged on an inner wall of both sides of a kiln wall. A set of all-oxygen burning guns are arranged on top of the kiln. The precious metal channel includes a molten glass mixed flow stirring section. Two molten glass heating-clarifying-cooling sections are connected in parallel at one end of the molten glass mixed flow stirring section, and one end of the two molten glass heating-clarifying-cooling sections are connected to the kiln. The other end of the molten glass mixed flow stirring section is also connected with a liquid supply tank. The liquid supply tank is connected with the liquid inlet of the tin bath.

On the basis of the above solution, the following further technical solution can be provided:

The flame injection ports of the set of all-oxygen burning guns are vertically downward, and the flame can reach a liquid surface of the molten glass in the kiln.

The precious metal channel includes the molten glass heating-clarifying-cooling sections, the molten glass mixed flow stirring section, and the liquid supply tank that are connected in sequence.

The molten glass heating-clarifying-cooling sections include a heating channel with one end connected to the kiln, and the other end connected to a clarification tank and a cooling channel are connected in sequence.

The molten glass mixed flow stirring section includes a confluence channel. One end of the confluence channel is connected with the two cooling channels. A set of spoilers are arranged in the confluence channel. At least one molten glass stirring tank is connected at the other end of the confluence channel. The liquid outlet of the molten glass stirring tank is connected with the liquid supply tank.

Each of spoilers in the set of spoilers is distributed in a staggered manner, and a section of serpentine flow channel is divided in the confluence channel by the division of the set of spoilers.

At least one molten glass stirring tank is connected in sequence at the other end of the confluence channel.

When a plurality of molten glass stirring tanks (1b) are included, the stirring directions of two adjacent molten glass stirring tanks are different.

The temperature of the liquid inlet of the tin bath is 1200-1400° C., and the temperature of the liquid outlet of the tin bath is 650-850° C.

A mixed protective gas of nitrogen and hydrogen is introduced into the tin bath, wherein the proportion of hydrogen is 3-8%.

In the annealing kiln, temperature zones A, B, C, D, Ret and F are divided from the entrance to the exit, wherein the temperature of the temperature zone A is 600-800° C., the temperature of the temperature zone B is 500-700° C., the temperature of the temperature zone C is 400-600° C., the temperature of the temperature zone D is 300-500° C., the temperature of the temperature zone Ret is 200-400° C., the temperature of the temperature zone F is 50-200° C., and a free cooling zone E provided with an open kiln wall is arranged between the temperature zone Ret and the temperature zone F.

The advantages of the invention:

The TFT-LCD glass substrate production line of the invention can stably produce large-size TFT-LCD glass substrates such as 8.5 generations and 10.5/11 generations, and have the advantages of large product size, excellent product performance, high production efficiency, high productivity and the like.

### BRIEF DESCRIPTION OF DRAWINGS

In order to more clearly describe the technical solutions of the embodiments of the present application or of the prior art, drawings that need to be used in embodiments and the prior art will be briefly described below. Obviously, the drawings provided below are for only some embodiments of the present application; those skilled in the art can also obtain other drawings based on these drawings without any creative efforts.

FIG. 1 is a schematic diagram of the structure of the present invention;

FIG. 2 is a schematic diagram of the structure of the kiln in FIG. 1;

FIG. 3 is a schematic diagram of the structure of the precious metal channel in FIG. 1;

FIG. 4 is a schematic diagram of the structure of the annealing kiln in FIG. 1.

### DETAILED DESCRIPTION

In order to make the objectives, technical solutions, and advantages of the present application clearer and more understandable, the present application will be described in more detail below with reference to the appended drawings and embodiments. Obviously, the described embodiments are only some, and not all, of the embodiments of the present application. All other embodiments obtained based on the embodiments of the present application by those skilled in the art without any creative efforts fall into the scope of protection defined by the present application.

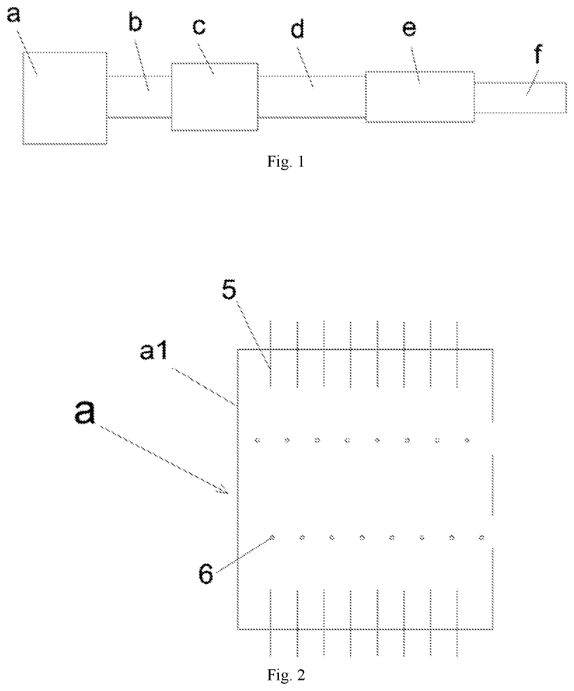

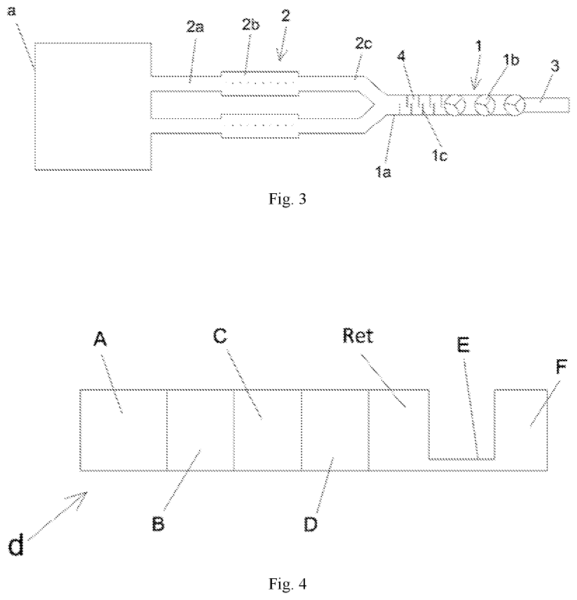

As shown in FIGS. 1-4, a high-generation TFT-LCD glass substrate production line includes a kiln a, a precious metal channel b, a tin bath c, an annealing kiln d, a cutting machine e, and an unloading machine f connected in sequence. The kiln a includes a set of electrodes 5 symmetrically arranged on an inner wall of both sides of a kiln wall a1. A set of all-oxygen burning guns 6 are arranged on top of the kiln a. The all-oxygen burning guns 6 are distributed vertically. The flame injection ports are vertically downward, and the flame can reach the liquid surface of the molten glass in the kiln a. While significantly increasing the flame heating efficiency, the flame can also eliminate foams that float on the liquid surface. The set of all-oxygen burning guns 6 are distributed in two rows and the two rows of all-oxygen burning guns 6 are distributed in a staggered manner.

The production capacity of the kiln a is 20˜100 tons/day. The production capacity which is less than 20 tons/day may cause low melting efficiency and high cost, and the production capacity which is more than 100 tons/day may cause the molten glass to not be fully and efficiently melted and affect the substrate quality of the substrate glass.

In some embodiments of the present application, the precious metal channel is a large-flow precious metal channel.

The precious metal channel includes a molten glass mixed flow stirring section 1. Two molten glass heating-clarifying-cooling sections 2 are connected in parallel at one end of the molten glass mixed flow stirring section 1, and one end of the two molten glass heating-clarifying-cooling sections 2 are connected to the kiln a.

The molten glass heating-clarifying-cooling sections 2 includes a heating channel 2a connected to the kiln a at one end, and a clarification tank 2b and a cooling channel 2c are connected in sequence at the other end of the heating channel 2a. The diameter of the heating channel 2a is 150 mm-300 mm and the length is 500 mm-1500 mm; the diameter of the clarification tank 2b is 250 mm-400 mm and the length is 3000 mm-8000 mm; and the diameter of the cooling channel 2c is 220 mm-360 mm and length is 2000 mm-6000 mm. The maximum temperature of the heating channel 2a during operation is 1650° C., the maximum temperature of the clarification tank 2b during operation is 1670° C., and the temperature of the cooling channel 2c during operation is 1500° C.˜1550° C.

The molten glass mixed flow stirring section 1 includes a confluence channel 1a. One end of the confluence channel 1a is connected with the two cooling channels 2c. A set of spoilers 1c are arranged in the confluence channel 1a. At least one molten glass stirring tank 1b is connected at the other end of the confluence channel 1a. For example, there may be three molten glass stirring tanks 1b, and the stirring directions of the two adjacent molten glass stirring tanks 1b are different.

Each of spoilers 1c in the set of spoilers 1c is distributed in a staggered manner, and a section of serpentine flow channel 4 is divided in the confluence channel 1a by the division of the set of spoilers 1c. The diameter of the confluence channel 1a is 300 mm-500 mm; the diameter of the molten glass stirring tank 1b is 350 mm-550 mm and the stirring speed is 2 to 20 revolutions per minute. The heating channel 2a, the clarification tank 2b, the cooling channel 2c, the confluence channel 1a, the molten glass stirring tank 1b, the spoiler 1c and the liquid supply tank 3 are made of platinum rhodium alloy or platinum iridium alloy or platinum.

The liquid outlet of the last molten glass stirring tank 1b is in communication with a liquid supply tank 3, and the liquid outlet end of the liquid supply tank 3 is in communication with the liquid inlet of the tin bath c. The diameter of the liquid supply tank 3 is 300 mm-500 mm, and the temperature during operation is 1200° C.˜1400° C.

The temperature of the liquid inlet of the tin bath c is 1200-1400° C., and the temperature of the liquid outlet of the tin bath c is 650-850° C. A mixed protective gas of nitrogen and hydrogen is introduced into the tin bath c, wherein the proportion of hydrogen is 3-8%. In the tin bath c, a correspondingly matched edge drawing machine is also provided. The tin bath c and the edge drawing machine are prior arts, so the structure and the matching relationship between the tin bath c and the edge drawing machine are not described here.

The liquid outlet of the tin bath c is communicated with the annealing kiln d through a transition roller table. Temperature zones A, B, C, D, Ret and F are divided from the inlet to the outlet in the annealing kiln d, wherein the temperature of the temperature zone A is 600-800° C., the temperature of the temperature zone B is 500-700° C., the temperature of the temperature zone C is 400-600° C., the temperature of the temperature zone D is 300-500° C., the temperature of the temperature zone Ret is 200-400° C., the temperature of the temperature zone F is 50-200° C., and a free cooling zone E provided with an open kiln wall is arranged between the temperature zone Ret and the temperature zone F. After the glass plate is annealed in the annealing furnace d, the surface temperature is ≤70° C., the internal stress is less than 50 Psi, and the overall plate warpage is less than 0.1 mm.

Then the glass plate enters the cutting machine e through the conveying roller, and is cut, edged, and broken into qualified glass sheets, and then taken, stacked and boxed under the action of the unloading machine f. The cutting machine e and the unloading machine f are mature products in the prior art, so the structure of the cutting machine e and the unloading machine f will not be described here.

The embodiments described above are simply preferable embodiments of the present application, and are not intended to limit the scope of protection of the present application. Any modifications, alternatives, improvements, or the like within the spirit and principle of the present application shall be included within the scope of protection of the present application.

1. A high-generation TFT-LCD glass substrate production line, comprising a kiln, a precious metal channel, a tin bath, an annealing kiln, a cutting machine, and an unloading machine connected in sequence, the kiln comprising a set of electrodes symmetrically arranged on an inner wall of both sides of a kiln wall, wherein, a set of all-oxygen burning guns are arranged on top of the kiln; the precious metal channel comprises a molten glass mixed flow stirring section, two molten glass heating-clarifying-cooling sections are connected in parallel at one end of the molten glass mixed flow stirring section, one end of the two molten glass heating-clarifying-cooling sections are connected to the kiln, the other end of the molten glass mixed flow stirring section is also connected with a liquid supply tank, and the liquid supply tank is connected with a liquid inlet of the tin bath.

2. The high-generation TFT-LCD glass substrate production line according to claim 1, wherein, flame injection ports of the set of all-oxygen burning guns are vertically downward, and flame can reach a liquid surface of the molten glass in the kiln.

3. The high-generation TFT-LCD glass substrate production line according to claim 1, wherein, the molten glass heating-clarifying-cooling sections include a heating channel with one end connected to the kiln, and the other end connected to a clarification tank and a cooling channel in sequence.

4. The high-generation TFT-LCD glass substrate production line according to claim 3, wherein, the molten glass mixed flow stirring section includes a confluence channel, wherein one end of the confluence channel is connected with the two cooling channels, a set of spoilers are arranged in the confluence channel, at least one molten glass stirring tank is connected at the other end of the confluence channel, and the liquid outlet of the molten glass stirring tank is connected with the liquid supply tank.

5. The high-generation TFT-LCD glass substrate production line according to claim 4, wherein, each of spoilers in the set of spoilers is distributed in a staggered manner, and a section of serpentine flow channel is divided in the confluence channel by the division of the set of spoilers.

6. The high-generation TFT-LCD glass substrate production line according to claim 4, wherein, at least one molten glass stirring tank is connected in sequence at the other end of the confluence channel.

7. The high-generation TFT-LCD glass substrate production line according to claim 6, wherein, when a plurality of molten glass stirring tanks are included, stirring directions of two adjacent molten glass stirring tanks are different.

8. The high-generation TFT-LCD glass substrate production line according to claim 1, wherein, the temperature of the liquid inlet of the tin bath is 1200-1400° C., and the temperature of the liquid outlet of the tin bath is 650-850° C.

9. The high-generation TFT-LCD glass substrate production line according to claim 1, wherein, a mixed protective gas of nitrogen and hydrogen is introduced into the tin bath, wherein the proportion of hydrogen is 3-8%.

10. The high-generation TFT-LCD glass substrate production line according to claim 1, wherein, in the annealing kiln, temperature zones A, B, C, D, Ret and F are divided from an entrance to an exit, wherein temperature of the temperature zone A is 600-800° C., temperature of the temperature zone B is 500-700° C., temperature of the temperature zone C is 400-600° C., temperature of the temperature zone D is 300-500° C., temperature of the temperature zone Ret is 200-400° C., temperature of the temperature zone F is 50-200° C., and a free cooling zone E with an open kiln wall is arranged between the temperature zone Ret and the temperature zone F.
